(19) United States
(12) Patent Application Publication
(10) Pub. No.: US 2026/0095393 A1
(43) Pub. Date: Apr. 2, 2026

(54) MANAGEMENT APPARATUS, STORAGE MEDIUM, AND METHOD

(71) Applicant: CANON KABUSHIKI KAISHA, Tokyo (JP)

(72) Inventor: TOSHIYUKI NAKAZAWA, Tokyo (JP)

(21) Appl. No.: 19/324,273

(22) Filed: Sep. 10, 2025

(30) Foreign Application Priority Data
Sep. 27, 2024 (JP) 2024-168719

(51) Int. Cl. H04L 41/22

(52) U.S. Cl. CPC H04L 41/22

(57) ABSTRACT

A management apparatus for providing information for managing network devices includes at least one memory storing instructions; and at least one processor executing the stored instructions causing the management apparatus to manage information including task information of a plurality of tasks including tasks scheduled to be executed and tasks being executed, provide, on a display, a dashboard including panels based on the managed information, wherein, as one of the panels in the dashboard, a first panel configured to display a list of tasks based on the task information and a first user interface associated with each task is provided, and provide, in a case where the first user interface is operated on the first panel, display of details of a task associated with the first user interface.

### BACKGROUND

### Field of the Technology

The present disclosure relates to a management apparatus, a storage medium, and a method.

### Description of the Related Art

There is technology for managing devices connected to a network. In this technology, various services, functions, and the like for one or a plurality of devices can be defined as tasks, and tasks can be executed at specified dates, times, periods, and the like. Japanese Patent Application Laid-Open No. 2011-141697 discloses a method for controlling tasks in a case in which a plurality of tasks are executed in combination. The technology disclosed in Japanese Patent Application Laid-Open No. 2011-141697 enables confirmation of detailed settings including plans for executing each task by opening a screen for editing tasks from a list of created tasks.

However, the technology disclosed in Japanese Patent Application Laid-Open No. 2011-141697 relates to control of execution of tasks, and does not provide a function for presenting information of tasks scheduled to be executed or tasks being executed to users. In practice, it is desirable to be able to confirm the execution status of tasks being executed by displaying, on a dashboard or the like, a list of tasks scheduled to be executed, the date and time at which tasks are scheduled to be executed, and a list of tasks being executed. However, in the technology, in a case in which a plurality of tasks are created, the execution state of each task such as executed, executing, scheduled for execution, and the like cannot be known from the list of created tasks. Furthermore, although it is possible to ascertain the execution status of tasks, when performing editing of tasks and the like, the technology requires manual reopening of a screen showing the list of created tasks, specifying tasks to be edited, and opening a screen for editing tasks, leaving room for improvement in operability.

### SUMMARY

The present disclosure is directed to provide a management apparatus, a storage medium, and a method capable of improving operability in a case in which tasks are managed.

According to an aspect of the present disclosure, a management apparatus for providing information for managing network devices includes at least one memory storing instructions; and at least one processor executing the stored instructions causing the management apparatus to manage information including task information of a plurality of tasks including tasks scheduled to be executed and tasks being executed, provide, on a display, a dashboard including panels based on the managed information, wherein, as one of the panels in the dashboard, a first panel configured to display a list of tasks based on the task information and a first user interface associated with each task is provided, and provide, in a case where the first user interface is operated on the first panel, display of details of a task associated with the first user interface.

Features of the present disclosure will become apparent from the following description of embodiments with reference to the attached drawings. The following description of embodiments is described by way of example.

### BRIEF DESCRIPTION OF THE DRAWINGS

FIG. 1 is an overall configuration diagram of a network device management system.

FIG. 2 is a block diagram showing an example of the hardware configuration of a host computer.

FIG. 3A and FIG. 3B are diagrams showing software configurations of a manager and an agent.

FIG. 4A and FIG. 4B are diagrams showing an example of a screen displaying a list of tasks created by a user and a screen for creating new tasks.

FIG. 5A and FIG. 5B are diagrams showing an example of a screen for executing creation or editing of new tasks and a screen for setting schedules of tasks.

FIG. 6A and FIG. 6B are diagrams showing an example of a dashboard screen.

FIG. 7A and FIG. 7B are diagrams showing an example of dialog display for displaying information showing details of tasks.

FIG. 8 is a flowchart showing a flow of processing when displaying information showing details of tasks.

### DESCRIPTION OF THE EMBODIMENTS

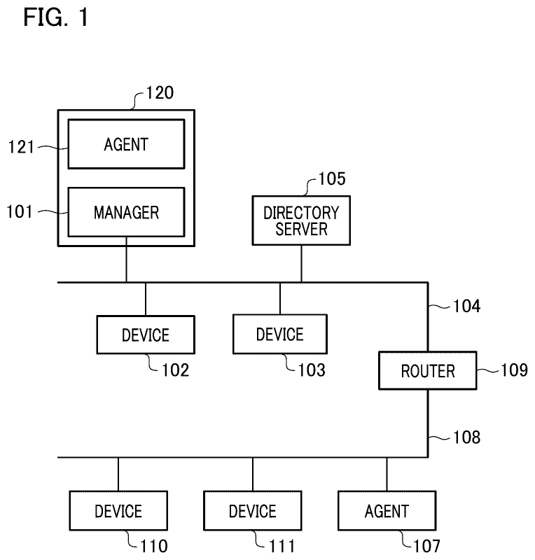

Hereinafter, embodiments for implementing the present disclosure will be described by using drawings. FIG. 1 is an overall configuration diagram of a network device management system. In the device management system, a manager configured to manage network devices (hereinafter referred to as “devices”) provides services to devices connected to a network via agents. In a case in which the number of devices to be managed is large, the device management system is configured on a large scale by a manager that performs overall management and a plurality of agents configured to execute processing on devices according to instructions of the manager. In contrast, in a case in which the number of devices to be managed is small, the device management system is configured on a small scale by a manager and agents on the same host.

In the example shown in FIG. 1, the device management system includes a manager 101, a directory server 105, an agent 121, an agent 107, a router 109, and a plurality of devices under management. The plurality of devices under management specifically includes a device 102, a device 103, a device 110, and a device 111. The agent 121 operates on a PC 120 that is the same host computer (hereinafter referred to as a host) as the manager 101. The PC 120 is an example of a management apparatus described below. In contrast, the agent 107 operates on a host different from the manager 101.

The device 102, the device 103, the device 110, and the device 111 are network devices managed by the manager 101. Among these four devices, the device 102 and the device 103 are connected to the same network 104 as the agent 121. Communication of the manager 101 with the device 102 and the device 103 is performed via the agent 121. The device 110 and the device 111 are connected to the same network 108 as the agent 107. Communication of the manager 101 with the device 110 or the device 111 is performed via the router 109 and the agent 107.

The manager 101, the directory server 105, the agent 121, the device 102, and the device 103 are mutually connected by a network 104. The network 104 is, for example, a WAN (Wide Area Network). The agent 107, the device 110, and the device 111 are mutually connected by the network 108. The network 108 is, for example, a LAN (Local Area Network). It should be noted that the network 104 and the network 108 need only be configured to enable transmission and reception of data, and any communication method may be adopted. For example, the network 104 and the network 108 may be configured by any of a LAN, a WAN, cellular networks such as LTE (Long Term Evolution) and 5G, wireless networks, telephone lines, dedicated digital lines, and the like, or combinations thereof.

The network 104 and the network 108 are connected by the router 109. The router 109 may be configured, for example, to permit communication between the manager 101 and the agent 107 on the network 108, but to block communication between the manager 101 and the device 110 or the device 111. It should be noted that in the present embodiment, as a large-scale configuration, two agents and four devices are described as examples. However, for example, even in a case in which tens of thousands of devices are managed via dozens of agents, configurations and operations are the same as the description of the present embodiment.

Although FIG. 1 explains an example in which the manager 101 and agents operate on both the same host and on different hosts, the present disclosure is not limited thereto. For example, in a case in which there are many devices that are targets of management and the device management system has a large-scale configuration, a plurality of agents are configured on hosts separate from the manager 101. In contrast, in a case in which there are few devices that are targets of management and the device management system has a small-scale configuration, the manager 101 and agents are configured on the same host, and no agents that operate on hosts different from the manager 101 exist. The configuration of the device management system in the present embodiment may be any of a configuration in which agents operate on the same host as the manager 101, a configuration in which agents operate on hosts different from the manager 101, and a configuration in which these configurations are mixed.

The manager 101 provides various services, functions, and the like for managing network devices that are targets of management. The manager 101 has a device management application. When providing services to devices, the manager 101 executes communication with devices by using agents. The manager 101 has a built-in web service server related to functions provided by the manager 101. It should be noted that the manager 101 may be realized by one or a plurality of information processing apparatuses, virtual machines using resources provided by data centers including information processing apparatuses, or combinations thereof. Virtual machines are a technology that forms a foundation of cloud computing.

The agent 107 and the agent 121 execute device management processing based on instructions of the manager 101. The agent 107 and the agent 121 have agent applications. The agent 107 and the agent 121 have built-in web service servers related to functions provided by the manager 101. In addition, the agent 107 and the agent 121 are respectively linked to devices according to device addresses or the like. The agent 107 is linked to the device 110 and the device 111.

The directory server 105 is an information processing apparatus that manages user information of user accounts and the like. The manager 101 and the directory server 105 are mutually connected by the network 104. The manager 101 can also be configured so that users of the directory server 105 can log in as users of the manager 101. The directory server 105 may be realized by one or a plurality of information processing apparatuses, virtual machines using resources provided by data centers including information processing apparatuses, or combinations thereof.

The device 102, the device 103, the device 110, and the device 111 are targets of management by the manager 101, and are network devices capable of communicating with the manager 101 via corresponding agents. Network devices are, for example, multifunction printers (MFP: Multifunction Printer) in which a plurality of functions such as printing functions, reading functions, FAX functions, and the like are integrated. It should be noted that network devices may be printers, scanner apparatuses, 3D printers, information processing apparatuses such as PCs (Personal Computers), image processing apparatuses such as cameras, smart home appliances, and the like.

Here, a flow of processing in which the network device management system executes provision of services to network devices will be explained using the agent 121 and the device 102 as examples.

The manager 101 instructs the agent 121 to perform operations on the device 102. The agent 121 communicates with the device 102 according to instructions of the manager 101, and performs operations of transmitting requests and the like to the device 102. Then, the agent 121 transmits results of operations on the device 102 to the manager 101. Examples of operations of the agent 121 on the device 102 include acquisition of information from the device 102, changing of setting values of the device 102, instructions for installing applications on the device 102, instructions for updating firmware of the device 102, and the like. In this manner, communication is executed between the manager 101 and the agent 121, and between the agent 121 and the device 102. For this reason, the device 102 and the manager 101 do not communicate directly.

In the present embodiment, the configuration is capable of supporting such large-scale configurations. However, a single network device management application having both functions of a manager and of agents may be configured so as to manage network devices.

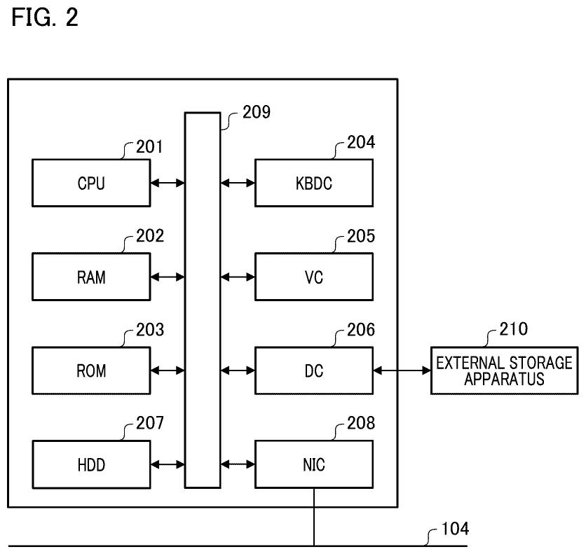

FIG. 2 is a block diagram showing an example of a hardware configuration of a host computer. Specifically, FIG. 2 shows a hardware configuration of an information processing apparatus on which a manager and agents operate. Although the manager 101 is explained here as an example, the host computer on which the agent 121, the agent 107, or the directory server 105 operates, and the PC 120, also have hardware configurations similar to the manager 101.

The manager 101 comprises a CPU (Central Processing Unit) 201, a RAM (Random Access Memory) 202, a ROM (Read Only Memory) 203, and a KBDC 204. In addition, the manager 101 comprises a VC (Video Controller) 205, a DC (Disk Controller) 206, an HDD (Hard Disk Drive) 207, and a NIC (Network Interface Controller) 208. These components are connected to a system bus 209.

The CPU 201 controls the entirety of the manager 101. The CPU 201 loads programs stored in memories, for example, the ROM 203, the HDD 207, and the like into the RAM 202 as required and executes the programs, and comprehensively controls each unit connected to the system bus 209. In addition, the CPU 201 may comprehensively control each unit connected to the system bus 209 by loading software, programs, and the like downloaded via a network into the RAM 202 as required and executing the software, programs, and the like.

The RAM 202 is a memory capable of reading and writing data, and functions as main memory of the CPU 201, a work area, and the like. The ROM 203 is a memory dedicated to data reading, and stores, for example, a basic control program of the manager 101 and the like. The HDD 207 stores various applications including a boot program, an operating system (OS: Operating System), an authentication client, and the like, as well as certificates, data, and the like. An external storage apparatus 210 is a memory, for example, an HDD, an SSD, and the like. The external storage apparatus 210 stores various applications, database data, user files, and the like.

The KBDC 204 controls input to the manager 101. The KBDC 204 sends input information from input devices such as a keyboard and a pointing device (not shown), and input information from a virtual keyboard, voice, and the like to the CPU 201, and controls input to the manager 101. The VC 205 controls display to a display apparatus (not shown). The display apparatus may be, for example, a liquid crystal display (LCD: Liquid Crystal Display), or may be a head mounted display (HMD: Head Mounted Display) capable of displaying virtual reality (VR: Virtual Reality), and the like.

The DC 206 controls access to the external storage apparatus 210. The NIC 208 is a communication controller. The manager 101 is connected to the network 104 via the NIC 208. The CPU 201 connects to the network 104 via the NIC 208, and enables data communication with each device on the network.

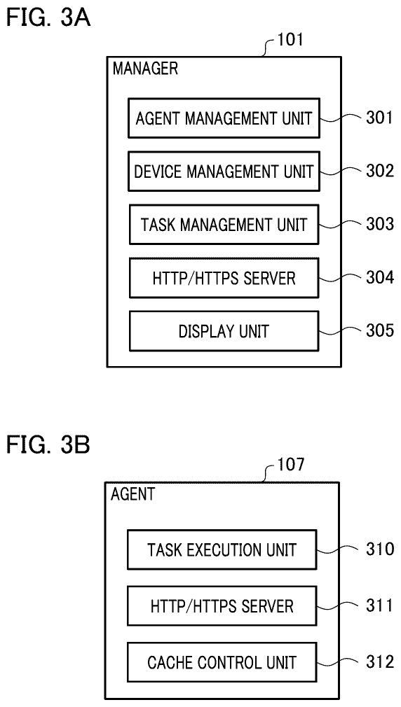

FIG. 3A and FIG. 3B are diagrams showing software configurations of a manager and agents. Specifically, FIG. 3A and FIG. 3B are diagrams for explaining software configurations of a device management server and agents. FIG. 3A is a diagram for explaining a software configuration of the manager 101.

The manager 101 shown in FIG. 3A has the main functions of a management apparatus that manages network devices, and comprises a management unit and a provision unit.

The management unit manages information of a plurality of tasks including tasks scheduled to be executed and tasks being executed. The provision unit provides, on a display, information for managing network devices. The provision unit provides a dashboard including panels indicating usage conditions of the management apparatus. In addition, the provision unit provides, as one of the panels, a panel configured to display a list of tasks based on information of the plurality of managed tasks and at least one first user interface associated with each task in the dashboard. Then, the provision unit provides display of details of the task associated with the first user interface in a case in which the first user interface is operated on the panel.

The provision unit may provide, as details of the task, a display of the schedule settings and settings specific to the type of the task associated with the first user interface that was operated from among the tasks displayed on the panel.

The first user interface may be a display portion of a name of the task displayed on the panel. Then, the provision unit may provide display of details of the task corresponding to the name in a case in which the display portion of the name of the task that is the first user interface is operated.

A second user interface may be further displayed in a screen for displaying details of the task. Then, the provision unit may further provide display of an editing screen for editing content of the task that was a target of the display of the details in a case in which the second user interface is operated.

The second user interface may be a display portion of a name of the task displayed in the screen for displaying details of the task. Then, the provision unit may provide display of an editing screen of the task corresponding to the name in a case in which the display portion of the name of the task that is the second user interface is operated.

It should be noted that the first user interface and the second user interface may be the same user interface.

The manager 101 realizes processing by functional modules shown in FIG. 3A by the CPU 201 calling an application program for device management from memory and executing the application program. The functional modules shown in FIG. 3A are provided, for example, as a device management application.

The manager 101 comprises an agent management unit 301, a device management unit 302, a task management unit 303, an HTTP/HTTPS server 304, and a display unit 305. The agent management unit 301 manages information related to agents in the system, that is, the agent 121 and the agent 107. The device management unit 302 manages information related to devices that are targets of management, for example, the device 102, the device 103, the device 110, and the device 111. Information related to devices includes information indicating agents linked to devices. The task management unit 303 executes management of tasks. For example, the task management unit 303 manages content of operations on devices, results, and the like. In addition, the task management unit 303 instructs agents to perform operations on devices through the execution of tasks. Management information managed by the task management unit 303 is stored in a database (not shown).

The HTTP/HTTPS server 304 is a web service server built into the manager 101 related to services provided by the manager 101. The HTTP/HTTPS server 304 receives requests from external apparatuses, for example, agents, devices, and the like, and returns responses to those requests. In addition, the HTTP/HTTPS server 304 provides a web user interface for users to operate the manager 101.

The display unit 305 controls display of screens provided by the manager 101. In the present embodiment, the display unit 305 displays a dashboard screen, a screen that shows a list of created tasks, and a screen for creating or editing tasks. The display unit 305 may display screens on a display apparatus (not shown) by controlling the VC 205, or may display screens in a web browser.

FIG. 3B is a diagram explaining the software configuration of agents. Although the agent 107 is explained here as an example, the other agent 121 also has a similar configuration. The agent 107 realizes processing by the functional modules shown in FIG. 3B by calling an application program for device management agents from memory and executing the application program by the CPU 201. The functional modules shown in FIG. 3B are functional modules related to services provided by the manager 101, and are provided, for example, as agent applications provided by the manager 101.

The agent 107 comprises a task execution unit 310, an HTTP/HTTPS server 311, and a cache control unit 312. The task execution unit 310 executes tasks instructed by the manager 101. The task execution unit 310 executes operations on devices according to instructions of the manager 101, and then transmits results of the operations to the manager 101.

The HTTP/HTTPS server 311 is a web service server built into the agent 107 related to services provided by the manager 101. The HTTP/HTTPS server 311 receives requests from external apparatuses such as the manager 101, devices, and the like. The manager 101 and the agent 107 communicate with each other mainly by using HTTPS via the HTTP/HTTPS server 304 of the manager 101 and the HTTP/HTTPS server 311 of the agent 107. The cache control unit 312 provides a cache function of content in the manager 101. Static content such as data for firmware updates can be stored in the agent 107 as a cache for a certain period. For this reason, in a case in which the same static content is requested from different devices, the agent 107 transmits the temporarily stored cache to devices, and can provide content at higher speed. In addition, by using the cache, communication between the manager 101 and the agent 107 becomes partially unnecessary, and load on the manager 101 is reduced.

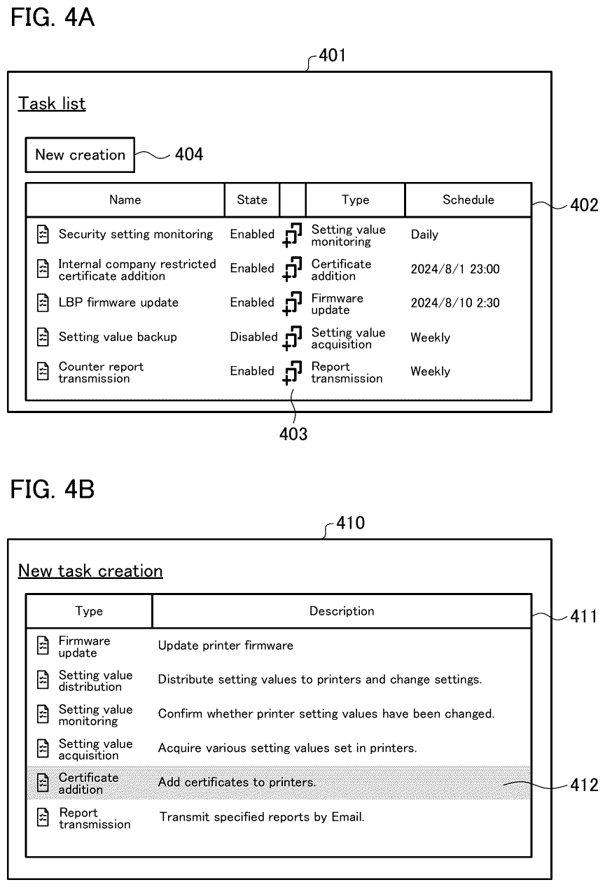

FIG. 4A and FIG. 4B are diagrams showing an example of a screen displaying a list of tasks created by a user and a screen for newly creating tasks. These screens are screens provided by the manager 101.

FIG. 4A is an example of screen display of a list of tasks created by a user. A task list display screen 401 is a screen provided by the task management unit 303 of the manager 101, and display thereof is controlled by the display unit 305. The task list display screen 401 displays a task list 402 created by the user and a button 404 for newly creating tasks. The task list 402 includes names of tasks, enabled/disabled states of tasks, a button 403 for duplicating tasks, types of tasks, and execution schedules of tasks. Upon detecting pressing of the duplication button 403 by the user, the manager 101 creates a duplicate of the task for which the duplication button 403 was pressed, and sets the state of the created task to “disabled.” In addition, upon detecting pressing of the duplication button 403 by the user, the manager 101 adds an indication that the task is a duplicate to the name. For example, the manager 101 sets the name to “Counter report transmission-duplicate.” Then, the manager 101 adds the created task to the task list 402.

The manager 101 displays, in schedules of the task list 402, schedules according to schedule settings of tasks. The manager 101 displays periods of schedules such as “daily” and “monthly” in a case in which tasks are executed periodically, such as daily or on the third Monday of every month. In addition, the manager 101 displays the date and time in a case in which tasks are executed only once at a specified date and time. The task list 402 also includes tasks that are not scheduled to be executed in the future, such as tasks having states that are “disabled” and tasks that have already finished execution at dates and times specified in the past.

In a case in which the manager 101 detects that a name field of each task in the task list has been clicked by the user, the manager 101 displays a screen for editing tasks described below. The screen is an example of the editing user interface described above. The name field of each task is an example of the first user interface and the second user interface described above. In addition, in the present embodiment, both the first user interface and the second user interface are names of tasks displayed on the panel. Clicking is an example of operations on the first user interface and the second user interface described above. In a case in which the manager 101 detects that the new creation button 404 has been pressed by the user, the manager 101 displays a task new creation screen 410 shown in FIG. 4B.

FIG. 4B is an example of a task new creation screen displayed by the manager 101 in a case in which pressing of the new creation button 404 shown in FIG. 4A is detected by the manager 101. The new creation screen 410 displays a list of types of tasks available for new addition. The user moves a cursor over a type of task to be newly added and clicks. Alternatively, the user moves a cursor over a type of task to be newly added and presses the Enter key. In a case in which the manager 101 detects the operations performed by the user, the manager 101 displays a screen for newly creating a task of the selected type described below.

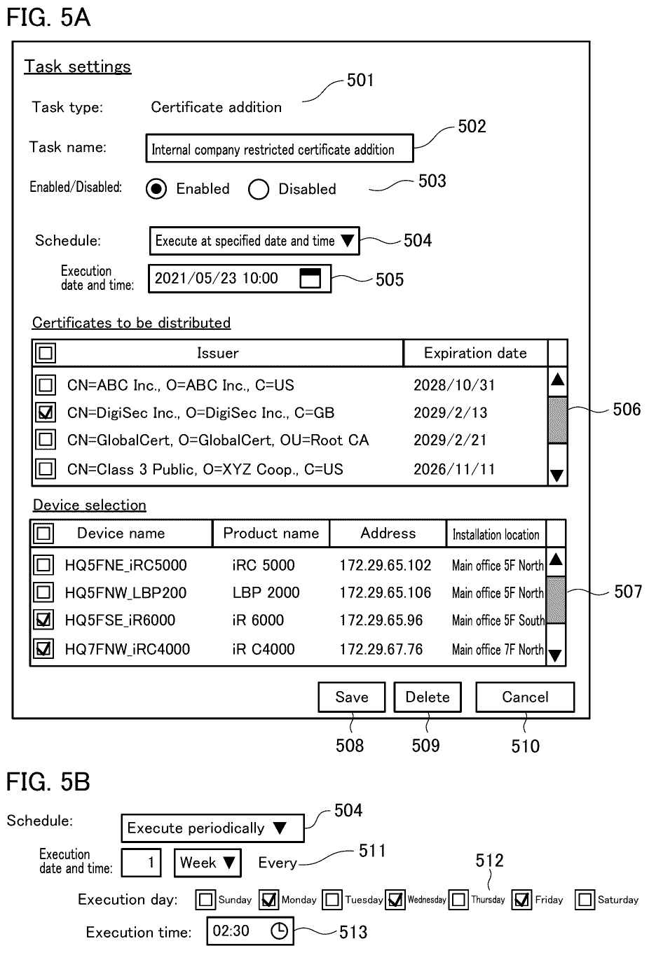

FIG. 5A and FIG. 5B are diagrams showing an example of a screen for executing new creation or editing of tasks and a screen for setting schedules of tasks. These screens are screens provided by the manager 101. FIG. 5A is displayed in a case in which the user selects “certificate addition” in the task new creation screen shown in FIG. 4B or in a case in which the user clicks a name of a task whose created type is “certificate addition” in the task list screen shown in FIG. 4A.

A task type field 501 is a field in which a type of task is displayed. A text box 502 is a field for inputting the name of the task. A radio button 503 is a user interface for setting enabled/disabled of the task. In a case in which the task is set to be disabled, the manager 101 does not execute the task. In a case in which the task is set to be enabled, the manager 101 executes the task according to schedules set by a dropdown 504, a date and time input component 505, an interval setting component 511, a day of week specification component 512, a time input component 513, and the like (see FIG. 5B).

The dropdown 504 is a user interface for specifying schedule settings. In the present embodiment, the dropdown 504 provides three options: “execute immediately,” “execute at specified date and time,” and “execute periodically.” The date and time input component 505 is a user interface for inputting date and time at which to execute the task. The date and time input component 505 is displayed by the manager 101 in a case in which the option “execute at specified date and time” is selected by the dropdown 504. In addition, the date and time input component 505 is not displayed by the manager 101 in a case in which the option “execute immediately” is selected by the dropdown 504.

FIG. 5B shows an example of a schedule setting screen in a case in which the option “execute periodically” is selected by the dropdown 504. The interval setting component 511 is a component for setting periods of “day,” “week,” and “month” and intervals thereof. The interval referred to here is, for example, every other week. The day of week specification component 512 is a component for specifying days of week on which to execute the task in the case of the period for executing the task being “week.” In the case of “month” being specified by the interval setting component 511, the manager 101 displays a component for setting the date of the month to the 25th and the like and a component for setting the day of week to the third Monday and the like. In the case of “day” being specified by the interval setting component 511, the manager 101 does not display the day of week specification component 512. The time input component 513 is a component for setting the execution time of the task. For example, in the example shown in FIG. 5B, execution of the task at 2:30 on Monday, Wednesday, and Friday every week is shown.

In FIG. 5A, a certificate list 506 is a component for selecting certificates to be distributed to printers. Certificates displayed in the certificate list 506 are registered in advance in the manager 101 by users using a certificate registration screen (not shown). A printer selection component 507 is a component for selecting printers to which to add certificates. The manager 101 displays, in a printer list in the printer selection component 507, printers having certificate addition functions among printers managed by the device management unit 302.

A save button 508 is a button for saving the content input by the user in the task editing screen. The manager 101 detects pressing of the save button 508 by the user, and in a case in which editing of the task has been performed, overwrites and saves to the task management unit 303 shown in FIG. 3A. In addition, the manager 101 detects pressing of the save button 508 by the user, and in a case in which new creation of the task has been performed, adds to the task management unit 303 shown in FIG. 3A. The manager 101 disables the save button 508 in a case in which the task editing screen has deficiencies, for example, in a case in which there is no input in task name input in the textbox 502 or in a case in which no day of week is selected in day of week selection of execution day specification in the interval setting component 511.

A delete button 509 is a button for deleting tasks. The manager 101 displays the delete button 509 only when an existing task is being edited. Upon detecting pressing of the delete button 509 by a user, the manager 101 displays a dialog for confirmation (not shown). Thereafter, the manager 101 deletes the task being edited from the task management unit 303 and transitions to the task list screen shown in FIG. 4A in a case in which the user agrees to deletion by the confirmation dialog. In contrast, the manager 101 closes the dialog and returns to the task editing screen shown in FIG. 5A in a case in which the user does not agree to deletion by the confirmation dialog.

A cancel button 510 is a button for interrupting editing of the task. Upon detecting pressing of the cancel button 510 by the user, the manager 101 discards content input by the user to the task editing screen and transitions to the task list screen shown in FIG. 4A.

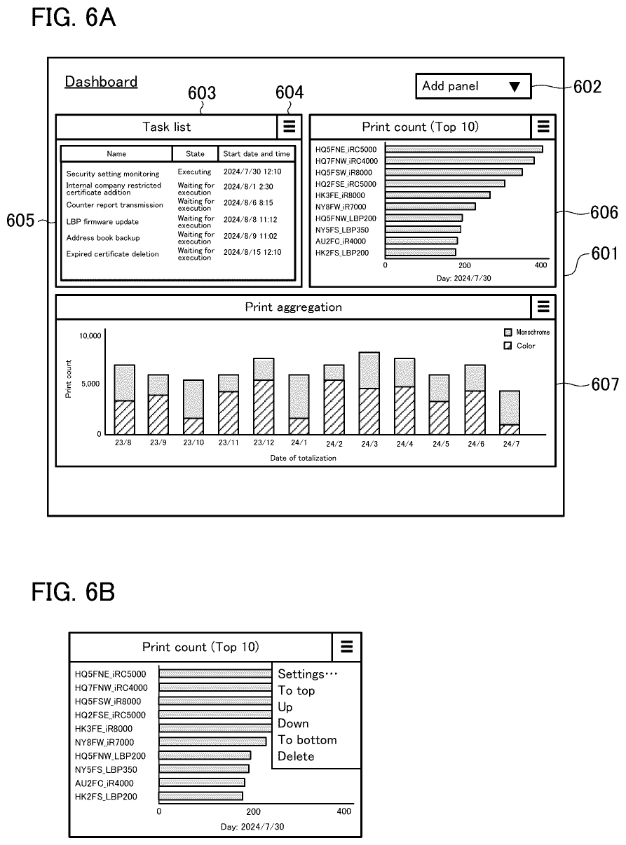

FIG. 6A and FIG. 6B are diagrams showing an example of a dashboard screen. A dashboard is a screen that enables confirmation of a plurality of graphs, tables, and the like in a list, and is for visually confirming various data collectively. The dashboard enables users to visually confirm data by graphs, tables, and the like, and therefore enables users to rapidly analyze or make judgments. A dashboard 601 includes a pulldown 602 for adding panels, and a panel 605, a panel 606, and a panel 607. The panel 605, the panel 606, and the panel 607 are all configured by a title 603, a menu 604, and a main body having different content depending on the type of panel. In addition, among these panels, there are panels having fixed panel widths and panels capable of switching panel widths between full width and half width.

The pulldown 602 is used for adding panels. Upon detecting clicking by the user, the manager 101 displays a list of types of panels that can be added, and additionally displays a panel of a type selected from the list by the user at the end of a displayed panel list. The title 603 enables users to change order in which panels are displayed by performing drag & drop by using pointing devices such as mice and the like.

In a case in which the manager 101 detects that the menu 604 of the panel 606 has been clicked, the manager 101 displays menus for changing panel settings, changing display order, and deleting the panel, as shown in FIG. 6B. Panel settings are configured by settings common to each panel, such as changing panel names and changing panel widths, and settings specific to types of panels. It should be noted that these are not shown. Settings specific to types of panels are, for example, in a case of the panel 607 shown in FIG. 6A, units of aggregation such as year, month, week, day, and the like, and specification of details of graphs to be displayed. In the example shown in FIG. 6A, the unit of aggregation is “month.” In addition, details of graphs are, for example, distinctions between color and monochrome, and distinctions between double-sided printing and single-sided printing.

The panel 605 shows a task list. The manager 101 acquires a list of tasks being executed and tasks waiting for execution from the task management unit 303, and displays the acquired list. The panel 605, in the example shown in FIG. 6A, displays names of each task, states, and dates and times at which tasks are started. The panel 605 enables users to easily judge execution status and plans for task execution as compared to the task list display screen 401 that has been created. In a case in which the manager 101 detects clicking of names of tasks in the task list displayed in the panel 605, the manager 101 displays a dialog for displaying detailed information of tasks described below.

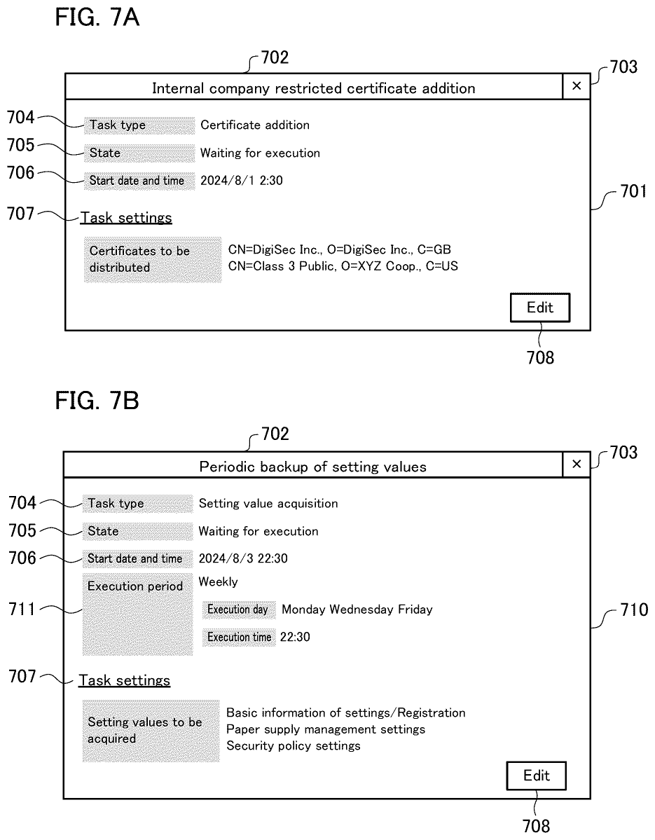

FIG. 7A and FIG. 7B are diagrams showing an example of dialog display for displaying information showing details of tasks. The dialog display shown in FIG. 7A and FIG. 7B displays detailed information of tasks, and the dialog display is displayed by clicking names of tasks included in the task list of the panel 605. FIG. 7A is an example of display (dialog 701) related to details of a task for adding certificates in a case in which the setting by the dropdown 504 shown in FIG. 5A is “execute at specified date and time.” FIG. 7B is an example of display (dialog 710) related to details of a task for acquiring setting values in a case in which the setting by the dropdown 504 shown in FIG. 5A is “execute periodically.”

A title bar 702 displays the name of the task. A button 703 is provided for the purpose of closing the dialog. In a case in which pressing of the button 703 by the user is detected, the manager 101 clears display of the dialog and displays the dashboard 601. A task type field 704 displays the type of the selected task. A status field 705 displays the execution status of the selected task. A start date and time field 706 displays the date and time at which the selected task is started. In a case in which setting by the dropdown 504 shown in FIG. 5A is “execute periodically,” the manager 101 displays setting of periodic execution in an execution period field 711. A task setting display 707 displays task settings that differ for each type of task.

In a case in which the manager 101 detects pressing of an edit button 708 by the user, the manager 101 transitions the screen display from the task details dialog display shown in FIG. 7A and FIG. 7B to display of the task editing screen for the selected task. For example, in a case in which the edit button 708 is pressed in FIG. 7A, a setting screen such as the setting screen shown in FIG. 5A for editing setting content of the task for addition of company-internal restricted certificates is displayed. It should be noted that even in a case in which the user performs a selection operation on the display portion of the name of the task in the title bar 702 in the dialog display screen of details of tasks shown in FIG. 7A and FIG. 7B, display may be transitioned to the task editing screen shown in FIG. 5A.

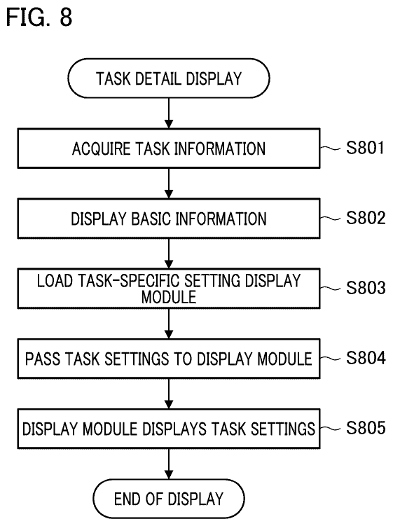

FIG. 8 is a flowchart showing a flow of processing when displaying information showing details of tasks. Specifically, FIG. 8 shows a flow of processing when the manager 101 displays the dialog 701 and the dialog 710 that display detailed information of tasks shown in FIG. 7A and FIG. 7B.

In step S801, the manager 101 acquires task information of the selected task from the task management unit 303. The task information is configured by basic information including the task name, the type of task, the status, the start date and time, and schedule information, and by task individual information in which task-specific settings are serialized in a format such as JSON (JavaScript Object Notation) and the like. By serializing and holding task individual information, it becomes possible to save task-specific settings as one piece of task data in a database and the like, similar to basic information. In addition, thereby, task duplication by pressing the duplication button 403 shown in FIG. 4A can also be easily achieved.

In step S802, the manager 101 displays the name of the task, the type of the task, the execution status of the task, the date and time at which the task is started, and the period of periodic execution as basic information. In step S803, the manager 101 loads a display module for task settings that differ for each type of task. In step S804, the manager 101 passes task individual information included in the task information acquired in step S801 to the loaded display module. In step S805, the display module for task settings deserializes the passed task individual information, creates task individual display information that reflects the task individual information, and returns the task individual display information to the caller. The task detailed information display processing receives the task individual display information and ends after the task individual display information is displayed in the task setting display 707. It should be noted that in a case in which user operations are performed in a web browser, the above-described task individual display information is described in HTML.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, a management apparatus, a storage medium, and a method capable of improving operability in a case in which tasks are managed can be provided.

This application claims the benefit of Japanese Patent Application No. 2024-168719 filed Sep. 27, 2024, which is hereby incorporated by reference herein in its entirety.

What is claimed is:

1. A management apparatus for providing information for managing network devices, the management apparatus comprising:
at least one memory storing instructions; and
at least one processor executing the stored instructions causing the management apparatus to
manage information including task information of a plurality of tasks including tasks scheduled to be executed and tasks being executed,
provide, on a display, a dashboard including panels based on the managed information, wherein, as one of the panels in the dashboard, a first panel configured to display a list of tasks based on the task information and a first user interface associated with each task is provided, and
provide, in a case where the first user interface is operated on the first panel, display of details of a task associated with the first user interface.

2. The management apparatus according to claim 1,
wherein executing the stored instructions by the processor further causes the management apparatus to provide, as details of the task, display of settings specific to type of task associated with the first user interface that was operated from among the tasks displayed on the first panel and settings related to schedules.

3. The management apparatus according to claim 1,
wherein the first user interface is a display portion of a name of the task displayed on the first panel, and
wherein executing the stored instructions by the processor further causes the management apparatus to provide display of details of a task corresponding to the name in a case in which the display portion of the name of the task that is the first user interface is operated.

4. The management apparatus according to claim 1,
wherein a second user interface is further displayed in a screen for displaying details of the task, and
wherein executing the stored instructions by the processor further causes the management apparatus to further provide display of an editing screen for editing content of the task that was a target of the display of the details in a case in which the second user interface is operated.

5. The management apparatus according to claim 4,
wherein the second user interface is a display portion of a name of a task displayed in a screen for displaying details of the task, and
wherein executing the stored instructions by the processor further causes the management apparatus to provide display of an editing screen of a task corresponding to the name in a case in which the display portion of the name of a task that is the second user interface is operated.

6. A non-transitory storage medium storing a program of a management apparatus for providing information for managing network devices, causing a computer to perform each step of a method for the management apparatus, the method comprising:
managing information including task information of a plurality of tasks including tasks scheduled to be executed and tasks being executed,
providing, on a display, a dashboard including panels based on the managed information, wherein, as one of the panels in the dashboard, a first panel configured to display a list of tasks based on the task information and a first user interface associated with each task is provided, and
providing, in a case where the first user interface is operated on the first panel, display of details of a task associated with the first user interface.

7. A method for controlling a management apparatus for providing information for managing network devices, the method comprising:
managing information including task information of a plurality of tasks including tasks scheduled to be executed and tasks being executed,
providing, on a display, a dashboard including panels based on the managed information, wherein, as one of the panels in the dashboard, a first panel configured to display a list of tasks based on the task information and a first user interface associated with each task is provided, and
providing, in a case where the first user interface is operated on the first panel, display of details of a task associated with the first user interface.
